(19) United States
(12) Patent Application Publication
(10) Pub. No.: US 2014/0244633 A1
(43) Pub. Date: Aug. 28, 2014

(54) RELEVANCE-WEIGHTED ATTRIBUTE SORTING APPARATUS AND METHOD

(71) Applicant: WAL-MART STORES, INC., Bentonville, AR (US)

(72) Inventor: Sumit Taank, San Jose, CA (US)

(73) Assignee: Wal-Mart Stores, Inc., Bentonville, AR (US)

(21) Appl. No.: 13/781,580

(22) Filed: Feb. 28, 2013

(51) Int. Cl. G06F 17/30

(52) U.S. Cl. CPC G06F 17/3053
USPC 707/723

(57) ABSTRACT

A computer-implemented method is disclosed for sorting listings or search results. In the method, a computer system may receive a query from a client computer. The computer system may respond to the query with listings ranked according to corresponding relevance scores. Thereafter, the computer system may receive a request to sort the listings according to some numeric attribute (e.g., price) corresponding thereto. Accordingly, the computer system may calculate a modified sorting criterion for each of the listings. Each modified sorting criterion may be weighted by both the original relevance score and the numeric attribute of the corresponding listing. The computer system may then serve, to the client computer, the listings ranked according to the modified sorting criteria.

### BACKGROUND

1. Field of the Invention

This invention relates to computer-based search systems and more particularly to systems and methods for sorting listings based on one or more numeric attributes thereof.

2. Background of the Invention

Typical search engines return results ranking according to predicted relevance. Accordingly, the first or top listings presented to a human searcher by a search engine are typically those the search engine has predicted will most relevant. However, in certain situations, a human searcher may not find such a ranking to be particularly helpful. The human searcher may desires or need a different ranking. Accordingly, what is needed is a computer system configured to sort or rank search results or other listings in a way that may be more helpful for human searcher.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of one embodiment of a computer system in accordance with the present invention;

FIG. 2 is a schematic block diagram of one embodiment of communication that may occur between different nodes of a computer system in accordance with the present invention;

FIG. 3 is a schematic block diagram of one embodiment of a method that may be executed by a computer system in accordance with the present invention;

FIG. 4 is a schematic block diagram of one embodiment of a server or server system in accordance with the present invention;

FIG. 5 is a schematic block diagram of one embodiment of a sort module in accordance with the present invention;

FIG. 6 is an illustration of one embodiment of an algorithm for generating modified sorting criteria in accordance with the present invention;

FIG. 7 is an illustration of an alternative embodiment of an algorithm for generating modified sorting criteria in accordance with the present invention; and

FIG. 8 is a table illustrating various sortings or rankings that may be produced by a computer system in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

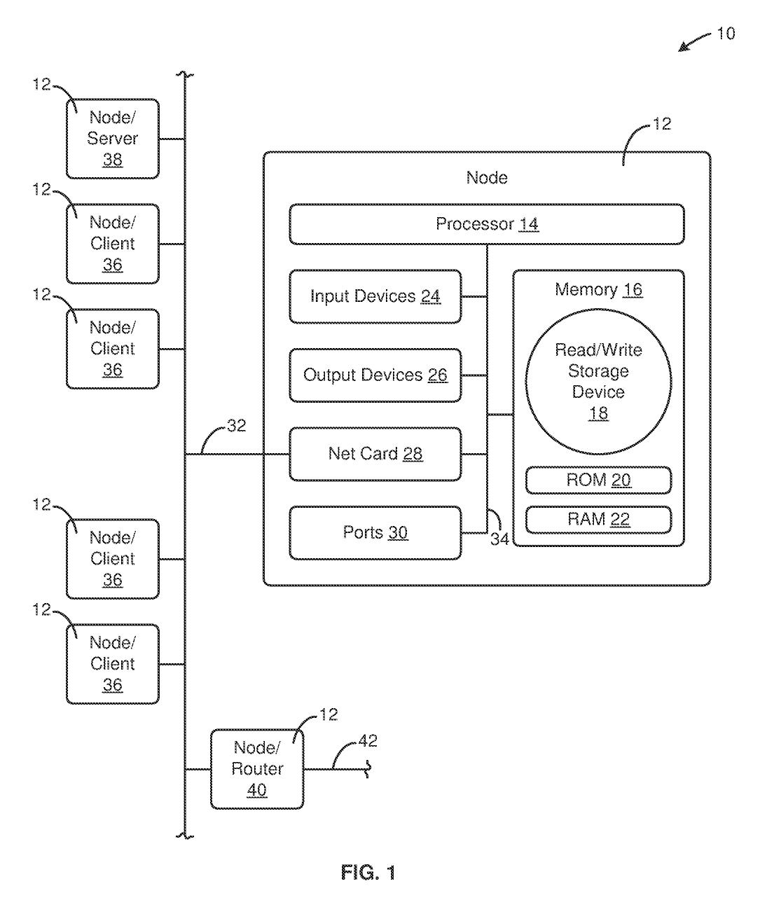

Referring to FIG. 1, a system 10 in accordance with the present invention may assist a human user in accessing information. For example, a human user may enter a query or request for information into a system 10. The system 10 may respond by providing one or more results or listings. The results or listings may initially be ranked or sorted according to relevance scores. However, the user may wish to view the results or listings according to some other order or ranking. Accordingly, a user may enter a sort request. That is, one or more results or listings may have one or more numeric attributes associated therewith. Accordingly, a user may enter a sort request requesting that the results or listings be sorted according to a numeric attribute.

In selected embodiments, acting upon a sort request, a system 10 may apply an algorithm to generate modified sorting criteria. Accordingly, in response to a sort request, a system 10 may provide the results or listings sorted or ranked based on a modified sorting criterion generated for each such result or listing. In certain embodiments, modified sorting criteria may be weighted or influenced by both relevancy scores and one or more numeric attributes. Accordingly, sorting listings based on modified sorting criteria may provide a new ranking that is more useful to a user because it is not identical to a ranking based exclusively on relevancy scores nor a ranking based exclusively on one or more numeric attributes.

A system 10 in accordance with the present invention may provide, enable, or support the generation and/or application of modified sorting criteria for relevance-weighted attribute sorting in any suitable manner. In certain embodiments, a system 10 may be embodied as hardware, software, or some combination thereof. For example, in selected embodiments, a system 10 may include one or more nodes 12.

A node 12 may include one or more processors 14 or central processing units (CPUs) 14. A node 12 may also include memory 16. Such memory 16 may be operably connected to a processor 14 and include one or more devices such as a hard drive 18 or other non-volatile storage device 18, read-only memory (ROM) 20, random access memory (RAM) 22, or the like or a combination or sub-combination thereof. In selected embodiments, such components 14, 16, 18, 20, 22 may exist in a single node 12. Alternatively, such components 14, 16, 18, 20, 22 may be distributed across multiple nodes 12.

In selected embodiments, a node 12 may include one or more input devices 24 such as a keyboard, mouse, touch screen, scanner, memory device, communication line, and the like. A node 12 may also include one or more output devices 26 such as a monitor, output screen, printer, memory device, and the like. A node 12 may further include a network card 28, port 30, or the like to facilitate communication through a computer network 32. Internally, one or more busses 34 may operably interconnect various components 14, 16, 24, 26, 28, 30 of a node 12 to provide communication therebetween. In certain embodiments, various nodes 12 of a system 10 may contain more or less of the components 14, 16, 24, 26, 28, 30, 34 described hereinabove.

Different nodes 12 within a system 10 may perform difference functions. For example, one or more nodes 12 within a system 10 may function as or be clients 36. Additionally, one or more nodes 12 within a system 10 may function as or be servers 38. Accordingly, a system 10 may include one or more servers 38 or the like serving files, data, applications, etc. to one or more clients 36 connected thereto. A system 10 may also include one or more nodes 12 that function as or are routers 40 and the like. Accordingly, one computer network 32 may be connected to other computer networks 42 via one or more routers 40.

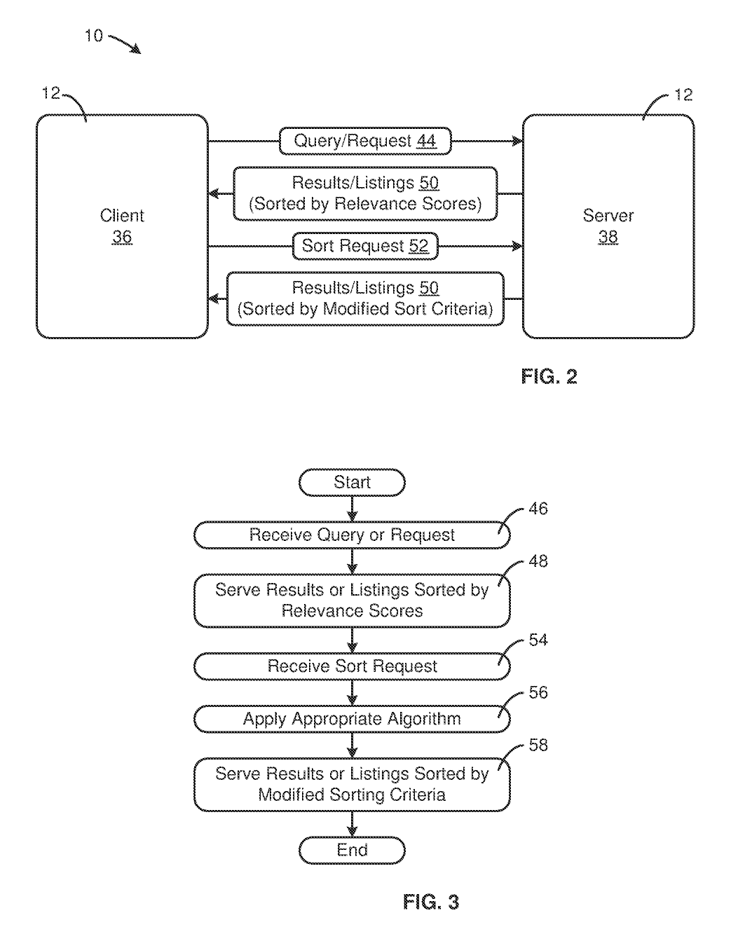

Referring to FIGS. 2 and 3, in selected embodiments, a system 10 may provide, enable, or support the generation of modified sorting criteria in the context of an exchange between nodes 12. For example, modified sorting criteria may be used in connection with one or more exchanges between a client 36 and server 38. Accordingly, relevancy-weighted attribute sorting may be applied to a plurality of listings passed between a client 36 and server 38.

For example, a client 36 may pass a query 44 or request 44 to a server 38. In general, such a query 44 or request 44 may be directed to certain content stored on, or accessed through, the server 38. Such content may have any suitable subject, combination of subjects, structure, or the like. For example, the content may comprise web pages, web postings, product listings (e.g., goods or services offered for sale), or the like or a combination or sub-combination thereof.

A server 38 may receive 46 the query 44 or request 44 and respond in any suitable manner. In selected embodiments, a server 38 may respond by serving 48 one or more results 50 or listings 50. For example, a query 44 may comprise something like “flat screen television.” Accordingly, a server 38 may respond by serving 48 a plurality of listings 50 that are likely to be relevant to someone submitting such a query 44.

In selected embodiments, the results 50 or listings 50 initially served 48 to a client 36 may be ranked or sorted according to relevance scores. Typically, the result 50 or listing 50 with the highest relevance score may be listed first, the result 50 or listing 50 with the second highest relevance score may be listed second, and so forth. However, a human user associated with a client 36 may wish to view the results 50 or listings 50 according to some other order or ranking. Accordingly, a human user may select or input, and a client 36 may pass, a sort request 52.

Results 50 or listings 50 may be sorted on any suitable basis. In selected embodiments, one or more results 50 or listings 50 may have one or more numeric attributes associated therewith. For example, various results 50 or listings 50 may contain or be associated with or linked to a price, customer score (e.g., average score assigned by customers to the product), popularity (e.g., total number of purchases), or the like or a combination or sub-combination thereof. Accordingly, a client 36 may pass a sort request 52 requesting that the results 50 or listings 50 be sorted according to a numeric attribute like price, customer score, popularity, etc.

A sort request 52 may be received 54 and acted upon by a server 38. In selected embodiments, acting upon a sort request 52 may include applying 56 an appropriate algorithm to a plurality of listings 50 or selected information corresponding thereto. For example, a server 38 may apply 56 an algorithm to generate modified sorting criteria. The results 50 or listings 50 may then be ranked according to the modified sorting criteria. Accordingly, in response to a sort request 52, a server 38 may serve 58 the results 50 or listings 50 sorted or ranked by the modified sorting criteria.

In selected embodiments, modified sorting criteria may be weighted or influenced by both relevancy scores and one or more numeric attributes. Accordingly, sorting a plurality of listings 50 based on modified sorting criteria may provide a new ranking that is not identical to a ranking based exclusively on relevancy scores nor a ranking based exclusively on one or more numeric attributes. In certain embodiments, sorting a plurality of listings 50 based on modified sorting criteria may result in more relevant listings 44 being represented in the top or leading locations at the cost of a less-than-strict sort according to the numeric attribute or attributes.

The flowchart in FIG. 3 illustrates the architecture, functionality, and operation of possible implementations of systems, methods, and computer program products according to certain embodiments of the present invention. In this regard, each block in the flowchart may represent a module, segment, or portion of code, which comprises one or more executable instructions for implementing the specified logical function(s). It will also be noted that each block of the flowchart illustration, and combinations of blocks in the flowchart illustration, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on one or more clients 36, servers 38, or combinations or sub-combinations thereof. In selected embodiments, one or more clients 36 and servers 38 may be positioned remotely with respect to one another. Accordingly, such nodes 12 may be connected to one another through any type of network, including a local area network (LAN) or a wide area network (WAN), or the connection may be made through the Internet using an Internet Service Provider.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Selected embodiments in accordance with the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

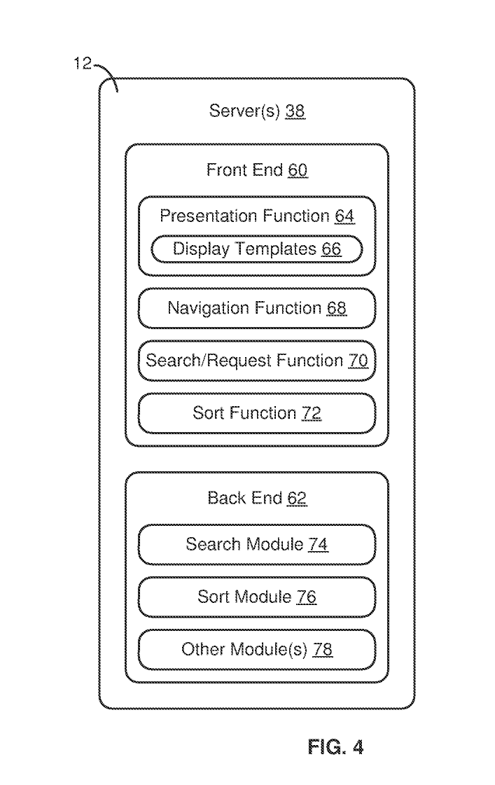

Referring to FIG. 4, in selected embodiments, a system 10 in accordance with the present invention may include one or more servers 38 supporting a website, mobile application, or the like or a combination thereof. One or more such servers 38 may comprise or support a “front end” 60 and/or a “back end” 62. A front end 60 may provide or support a user interface viewed or utilized by the human users of one or more clients 36. A back end 62, on the other hand, may perform, provide, or support the behind-the-scene work of processing queries, sorting listings, or the like or a combination thereof.

In certain embodiments, selected functions that may typically be associated with a front end 60 of a server 38 may be off loaded to one or more clients 36. For example, an application (e.g., a mobile application) installed on a client 36 (e.g., a desktop computer, laptop computer, tablet computer, smart phone, electronic reader, music player, or the like of a human user) may provide a user interface for a system 10 in accordance with the present invention. Accordingly, in selected embodiments, one or more servers 38 may primarily perform functions typically associated with a back end 62.

In selected embodiments, a front end 60 may include a presentation function 64 controlling the content and/or content format to be displayed via one or more clients 36 to the respective human users thereof. In certain embodiments, a presentation function 64 may include one or more display templates 66 defining the visual look supported by the front end 60 (e.g., the look of the various pages of a website or views or screens of an application). A front end 60 may also include a navigation function 68. A navigation function 68 may receive commands from a user via a client 36 and direct a presentation function 64 to display other templates, files, pages, screens, views, and the like.

A front end 60 may include a search or request function 70. A search or request function 70 may provide a mechanism through which one or more queries 44 or requests 44 may be passed to and/or received 46 by a server 38. Similarly, a front end 60 may include a sort function 72. A sort function 72 may provide a mechanism through which one or more sort requests 52 may be passed to and/or received 54 by a server 38.

In selected embodiments, a back end 62 may include a search module 74, sort module 76, one or more other modules 78 as desired or necessary, or the like or a combination or sub-combination thereof. A search module 74 may identify, collect, or compile a plurality of listings 50 or results 50 that are potentially relevant to one or more corresponding queries 44 or requests 44. A sort module 76 may rank or sort a plurality of listings 50 or results 50.

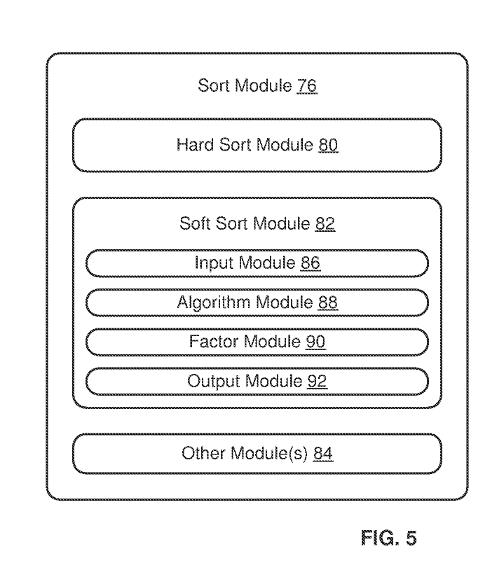

Referring to FIG. 5, a system 10 in accordance with the present invention may sort a plurality of listings 50, results 50, or the like in any suitable manner. In selected embodiments, a sort module 76 may provide, enable, or support such sorting. A sort module 76 may include any suitable arrangement of sub-components or modules. In certain embodiments, a sort module 76 may include a hard sort module 80, soft sort module 82, one or more other modules 84 as desired or necessary, or the like or some combination or sub-combination thereof.

A hard sort module 80 may strictly sort or rank a plurality of results 50 or listings 50 according to one or more numeric attributes. That is, in selected embodiments, one or more human users may not want a relevance-weighted attribute sorting of results 50 or listings 50. Accordingly, a hard sort module 80 may deliver a strict sort based on one or more numeric attributes as desired or requested.

A soft sort module 82 may provide or support relevance-weighted attribute sorting in accordance with the present invention. A soft sort module 82 may accomplish this in any suitable manner. A soft sort module 82 may include any suitable arrangement of sub-components or modules. In certain embodiments, a soft sort module 82 may include an input module 86, algorithm module 88, factor module 90, output module 92, one or more other modules as desired or necessary, or the like or some combination or sub-combination thereof.

An input module 86 may generate, collect, extract, receive, communicate, and/or process any inputs (e.g., instructions, information, etc.) needed or used by a soft sort module 76. For example, an input module 86 may receive a command or instruction to conduct a relevance-weighted attribute sorting process. Accordingly, an input module 86 may be responsible for initiating a relevance-weighted attribute sorting process. Alternatively, or in addition thereto, an input module 86 may collect, receive, extract, or communicate information such as one or more relevance scores, values for one or more numeric attributes, or the like or combinations thereof that may be used or processed by one or more other components or modules of a soft sort module 82.

An algorithm module 88 may store, generate, select, populate, and/or apply one or more algorithms to generate modified sorting criteria. For example, an algorithm module 88 may store multiple algorithms. In selected embodiments, one such algorithm may be selected and applied to generate a low-to-high sort, while another algorithm may be selected and applied to generate a high-to-low sort.

A factor module 90 may record, identify, select, and/or communicate one or more factors. Factors may be viewed as numeric weights. In selected embodiments, one or more algorithms in accordance with the present invention may include one or more factors. Proper selection of the particular values of those one or more factors may enable an algorithm to be tuned for a particular embodiment or situation. Accordingly, a factor module 90 may receive information characterizing a particular situation, plurality of listings 44, or the like and select one or more factors that may be appropriate therefor.

An output module 92 may generate, collect, compile, send, communicate, and/or process any outputs (e.g., instructions, information, etc.) of a soft sort module 76. For example, in selected embodiments, an output module 92 may receive a plurality of results 50 or listings 50 and corresponding modified sorting criteria, sort the results 50 or listings 50 according to the modified sorting criteria, and output the sorted version of the results 50 or listings 50 to be served 58 to an appropriate client 36.

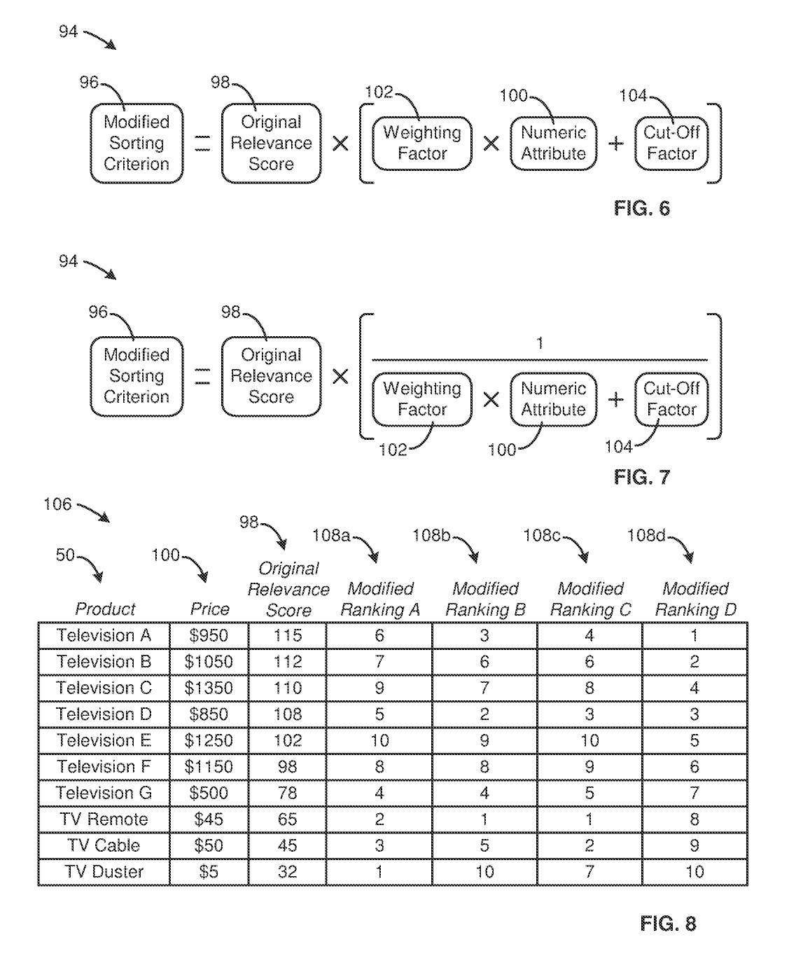

Referring to FIG. 6, an algorithm 94 in accordance with the present invention may generate, calculate, and/or output modified sorting criteria 96 weighted or influenced by both relevance scores 98 and one or more numeric attributes 100. In selected embodiments, a relevance score 98 may be a numeric value that characterizes an expected relevance of a corresponding result 50 or listing 50 to a particular query 44 or request 44. A relevance score 98 may be collected or generated by a search module 74 for each result 50 or listing 50. That is, within a plurality of results 50 or listings 50, each such result 50 or listing 50 may be linked to a corresponding relevance score 98.

An algorithm 94 may generate, calculate, and/or output modified sorting criteria 96 in any suitable manner. In selected embodiments, an algorithm 94 may mathematically combine a relevance score 98 and a numeric attribute 100 in some way that is appropriate to the situation involved. For example, in an environment where a higher relevance score 98 is indicative of greater predicted relevance and a numeric attribute 100 is price, a human user may request that certain listings 50 be sorted by price 100 from low to high. In such a situation, an algorithm 94 may generate a modified sorting criteria 96 by dividing each relevance score 98 by a respective price 100, subtracting each price 100 from a respective relevance score 98, or the like. Thus, a listing 50 with the highest relevance score 98 and lowest price 100 may have the highest modified sorting criterion 96.

Alternatively, in selected embodiments, an algorithm 94 may include a weighting factor 102, cut-off factor 104, or a combination thereof. A weighting factor 102 may be selected and applied to control how much a particular numeric attribute 100 factors into a corresponding modified sorting criterion 96. A cut-off factor 104 may set a selected “floor” below which no important results 50 or listings 50 are expected to fall. In general, a cut-off factor 104 may be selected based on the corresponding numeric attribute 100. For example, if, for a particular situation, no results 50 or listings 50 having a numeric attribute 100 (e.g., a numeric attribute 100 forming the basis of the sorting) below 500 are expected to relevant, a cut-off factor 104 may be set at 500 or thereabout.

In certain embodiments, the illustrated algorithm 94 may be suitable for use in an environment where a higher relevance score 98 is indicative of greater predicted relevance. This particular algorithm 94 multiplies a weighting factor 102 by a numeric attribute 100 of a particular result 50 or listing 50, and then adds in a cut-off factor 104. The algorithm 94 then multiplies the resulting sum by an original relevance score 98 corresponding to the particular result 50 or listing 50. Such an algorithm 94 may be suitable for a relevance-weighted, high-to-low attribute sorting, where a higher modified sorting criterion 96 corresponds to higher ranking.

Within an algorithm 94, the weighting and cut-off factors 102, 104 may have any suitable values. In selected embodiments (e.g., embodiments utilizing the illustrated algorithm 94), a weighting factor 102 may have a value in the range from about 0.1 to about 5. This range may be viewed in multiple parts or sections. For example, from about 0.1 to about 1 may be viewed as a “relaxed” range wherein the influence of a corresponding numeric attribute 100 is lowered or relaxed. From about 1 to about 5 may be view as an aggressive range wherein the influence of a corresponding numeric attribute 10 is increased or multiplied.

In selected embodiments, a number of results 50 or listings 50 being sorted may be considered when selecting an appropriate weighting factor 102. For example, a weighting factor 102 in the relaxed range may be well suited to sorting a larger number of listings 50, while a weighting factor 102 in the aggressive range may be well suited to sorting a smaller number of listings 50. That is, when the number of listings 50 or results 50 is relatively small, the numeric attribute 100 is given more influence. Conversely, when the number of listings 50 or results 50 is relatively large, the numeric attribute 100 is given less influence. In certain embodiments, a dividing line separating a larger number of listings 50 from a smaller number of listings 50 may be in the range from about 200 to about 1000, with about 400 being preferred in selected embodiments or situations.

Referring to FIG. 7, in selected embodiments, a single algorithm 94 may be used to provide both a low-to-high sort and a high-to-low sort for a particular numeric attribute 100. For example, an algorithm 94 may be applied to generate a plurality of modified sorting criterion 98, each criterion 98 thereof corresponding to a different result 50 or listing 50. To provide a low-to-high sort, the results 50 or listings 50 may be sorting by modified sorting criteria 96 from high-to-low. Conversely, to provide a high-to-low sort, the results 50 or listings 50 may be sorting by modified sorting criteria 96 from low-to-high.

Alternatively, in selected embodiments, one algorithm may be used to provide a low-to-high sort for a particular numeric attribute 100, while a different algorithm 94 may be used to provide a high-to-low sort for the particular numeric attribute 100. For example, the algorithm of FIG. 7 may be used to provide a low-to-high sort based on a numeric attribute 100 when the modified sorting criteria 96 is sorted from high-to-low. The algorithm of FIG. 6 may be used to provide a high-to-low sort based on a numeric attribute 100 when the modified sorting criteria 96 is sorted from high-to-low.

As may be noted, the algorithm 94 of FIG. 7 includes many of the same components 98, 100, 102, 104 as the algorithm 94 of FIG. 6. Moreover, one or more components (e.g., weighting factor 102, cut-off factor 104) of the algorithm 94 of FIG. 7 may be selected, in certain embodiments, to match those of FIG. 6. However, in FIG. 7 it is the inverse of the sum of the cut-off factor 104 and the product of the weighting factor 102 and numeric attribute 100 that is multiplied by the original relevance score 98.

Referring to FIG. 8, in selected embodiments, the effects of an algorithm 94 in accordance with the present invention, and one or more weighting factors 102 or cut-off factors 104 thereof, may be seen through example. Accordingly, in the illustrated table 106, a plurality of results 50 or listings 50 are shown in conjunction with a corresponding numeric attribute 100 (in this case price) and relevance score 98. As shown, the listings 50 are listed high-to-low according to relevance score 98 (e.g., as they may be served 48 in response to an initial query 44 or request 44). Additionally, four modified rankings 108 are shown. The numbers listed in the modified rankings 108 correspond to rank. Accordingly, a listing 50 corresponding to “1” in a modified ranking 108 would be the highest ranked listing 50, a listing 50 corresponding to “2” in a modified ranking 108 would be the second highest ranked listing 50, and so forth.

In the table 106, each modified ranking 108 corresponds to the algorithm of FIG. 7 with different weighting and cut-off factors 102, 104 applied. In the first modified ranking 108a, the weighting and cut-off factors 102, 104 have been set to 1.5 and 50, respectively. In the second modified ranking 108b, the weighting and cut-off factors 102, 104 have been set to 1.5 and 850, respectively. In the third modified ranking 108c, the weighting and cut-off factors 102, 104 have been set to 0.1 and 50, respectively. In the fourth modified ranking 108d, the weighting and cut-off factors 102, 104 have been set to 0.1 and 850, respectively.

As can be noted by comparing the first and third modified rankings 108a, 108c or the second and fourth modified rankings 108b, 108d, a change in the weighting factor 102 changes how much the numeric attribute 100 (i.e., price) factors into the ranking. In the first modified ranking 108a, with a weighting factor 102 of 1.5, the listings 50 are ranked almost strictly by price. Conversely, in the third modified ranking 108c, with a weighting factor 102 of 0.1, the listings 50 are ranked more according to relevance. Thus, in the third modified ranking 108c, a relatively inexpensive, but likely irrelevant, “TV Duster” has been significantly lowered in the overall rankings.

As can be noted by comparing the first and second modified rankings 108a, 108b or the third and fourth modified rankings 108c, 108d, a change in the cut-off factor 104 changes the floor below which no important results 50 or listings 50 are expected to fall. In the third modified ranking 108c, with a cut-off factor 104 set at 50, the listings 50 (e.g., TV Remote, TV Cable) that are priced around $50 rank well. Conversely, in the fourth modified ranking 108d, with a cut-off factor 104 of 850, the listings 50 that are priced around $50 have been significantly lowered in the overall rankings. Thus, in the fourth modified ranking 108d, the algorithm 94 accentuates or promotes listings 50 having a numeric attribute 100 near or above the cut-off factor 104.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A computer-implemented method for sorting search results, the method comprising:
obtaining, by a computer system, a plurality of listings, a plurality of relevance scores, and a plurality of first numeric attributes;
obtaining, by the computer system, information linking each listing of the plurality of listings to a corresponding relevance score of the plurality of relevance scores and a corresponding first numeric attribute of the plurality of first numeric attributes;
calculating, by the computer system, a modified sorting criteria, each modified sorting criterion thereof corresponding to a different listing of the plurality of listings and being weighted by both the corresponding relevance score and the corresponding first numeric attribute of the different listing; and
serving, by the computer system to a client computer, the plurality of listings ranked according to the modified sorting criteria.

2. The method of claim 1, further comprising serving, by the computer system to the client computer before the calculating, the plurality of listings ranked according to the plurality of relevance scores.

3. The method of claim 2, further comprising receiving, by the computer system from the client computer before the calculating, a request to sort the plurality of listings according to the plurality of first numeric attributes.

4. The method of claim 3, wherein the plurality of listings ranked according to the modified sorting criteria does not match the order that would be produced if the plurality of listings were strictly sorted according to the plurality of first numeric attributes.

5. The method of claim 4, further comprising receiving, by the computer system from the client computer, a search query.

6. The method of claim 5, wherein the plurality of listings comprise search results corresponding to the search query.

7. The method of claim 6, wherein the calculating comprises applying a weighting factor to each first numeric attribute of the plurality of first numeric attributes.

8. The method of claim 7, wherein the weighting factor affects the contribution of each first numeric attribute of the plurality of first numeric attributes in a corresponding modified sorting criterion of the modified sorting criteria.

9. The method of claim 8, wherein each first numeric attribute of the plurality of first numeric attributes comprises a price.

10. The method of claim 1, wherein each first numeric attribute of the plurality of first numeric attributes comprises a price.

11. A computer-implemented method for sorting search results, the method comprising:
receiving, by a computer system from a client computer, a query;
serving, by the computer system to the client computer as a response to the query, a plurality of listings ranked according to a plurality of relevance scores, each listing of the plurality of listings corresponding to a relevance score of the plurality of relevance scores;
receiving, by the computer system from the client computer, a request to sort the plurality of listings according to a plurality of numeric attributes, each listing of the plurality of listings corresponding to a numeric attribute of the plurality of numeric attributes;
calculating, by the computer system in response to the request, modified sorting criteria, each modified sorting criterion thereof corresponding to a different listing of the plurality of listings and being weighted by both the corresponding relevance score and the corresponding numeric attribute of the different listing; and
serving, by the computer system to the client computer, the plurality of listings ranked according to the modified sorting criteria.

12. The method of claim 11, wherein the plurality of listings ranked according to the modified sorting criteria does not match the order that would be produced if the plurality of listings were strictly sorted according to the plurality of numeric attributes.

13. The method of claim 11, wherein the calculating comprises applying a weighting factor to each numeric attribute of the plurality of numeric attributes.

14. The method of claim 13, wherein the weighting factor affects the contribution of each numeric attribute of the plurality of numeric attributes in a corresponding modified sorting criterion of the modified sorting criteria.

15. The method of claim 14, wherein each numeric attribute of the plurality of numeric attributes comprises a price.

16. The method of claim 11, wherein the plurality of numeric attributes comprises at least one of a plurality of prices, a plurality of user-review scores, and a plurality of sales numbers.

17. A computer system comprising:
one or more processors;
one or more memory devices operably connected to the one or more processors;
the one or more memory devices collectively storing
a search module programmed to receive a query and return, as a response to the query, a plurality of listings ranked according to a plurality of relevance scores, each listing of the plurality of listings corresponding to a relevance score of the plurality of relevance scores,
a sort module programmed to receive a request to sort the plurality of listings according to a plurality of numeric attributes, wherein each listing of the plurality of listings corresponds to a numeric attribute of the plurality of numeric attributes,
the sort module further programmed to calculate modified sorting criteria, each modified sorting criterion thereof corresponding to a different listing of the plurality of listings and being weighted by both the corresponding relevance score and the corresponding numeric attribute of the different listing, and
the sort module further programmed to return, as a response to the request, the plurality of listings ranked according to the modified sorting criteria.

18. The system of claim 17, wherein the sort module is programmed to calculate the modified sorting criteria by applying a weighting factor to each numeric attribute of the plurality of numeric attributes to modify the contribution of each numeric attribute of the plurality of numeric attributes in a corresponding modified sorting criterion of the modified sorting criteria.

19. The system of claim 17, wherein each numeric attribute of the plurality of numeric attributes comprises a price.

20. The system of claim 17, wherein the plurality of numeric attributes comprises at least one of a plurality of prices, a plurality of user-review scores, and a plurality of sales numbers.
